(19) United States
(12) Patent Application Publication
(10) Pub. No.: US 2012/0073065 A1
(43) Pub. Date: Mar. 29, 2012

(54) Tool for clearing intake grates on personal water craft

(75) Inventor: Mona Sue Phillips, Hopatcong, NJ (US)

(73) Assignee: Mona Sue Phillips, LLC

(21) Appl. No.: 12/923,494

(22) Filed: Sep. 24, 2010

(51) Int. Cl. A46B 5/06; B08B 9/04

(52) U.S. Cl. 15/104.2

(57) ABSTRACT

A length of multi-strand rope with gripping means at either end has in the midsection multiple semi-rigid, flexible fiber filaments, which are glued and/or intertwined among the rope strands, and which protrude from the rope to form “bristles” for clearing the water intake grates of a personal water craft.

### BACKGROUND OF THE INVENTION

The present invention generally relates to the field of tools and devices used to remove and/or clear weeds, debris and other obstructions from active mechanisms of water craft, such as water intakes and propellers. More particularly, the present invention relates to the field of tools and devices used to remove and/or clear obstructions from the water intake grates of personal water craft, such as jet skis.

The use of personal water craft, particularly jet skis, has become an increasingly popular form of marine recreation in recent decades. Such personal water craft are typically propelled by a jet system, which sucks water in through intake grates underneath the craft and expels an accelerated propulsive stream of water from the stern of the craft. It is therefore imperative that the intake grates be kept clear of weeds, aquatic organisms, debris and other obstructions that may be sucked into the intake grates. But the task of removing obstructions from the intake grates of personal water craft is a difficult and potentially hazardous one, since it can require someone to dive or wade under the craft and remain submerged while manually removing materials from the grates.

The purpose of the present invention is to provide a convenient and readily stowable tool that the operator can deploy from the deck of the personal water craft as often as needed to keep the intake grates free of obstructions.

### SUMMARY OF THE INVENTION

The present invention comprises a length of rope with gripping means at either end. In the midsection of the rope are glued and/or intertwined multiple semi-rigid, flexible fiber filaments, which protrude from the rope to form the “bristles” for clearing the water intake grates of a personal water craft.

The rope can be any type of multi-strand twisted or braided rope. Preferably, the rope is 3-strand twisted rope, commonly known as “plain rope”; but the rope can also be braided or any other type rope that comprises multiple component strands twisted or braided together. Regarding the material from which the rope is made, because the rope must be suitable for use in a marine environment, the material should be strong, waterproof, and floatable. Nylon and most natural fibers are not preferred, because they absorb water. Polyester, which is often used in nautical ropes, is also not preferred in this application because it sinks. It is preferable that the rope floats so that, if the device is accidentally dropped into the water, it can be more easily recovered. Therefore, the preferred rope material for the present invention is polypropylene, which is strong, flexible, waterproof, and floats. Optimally, the rope is ⅝-inch twisted polypropylene, approximately 14 feet in length. The gripping means on either end of the rope be rope loops, plastic or metal handles, taped hand grips, or other functionally equivalent structures.

The “bristles” of the device comprise multiple semi-rigid, flexible fiber filaments, which are intertwined and/or glued among the twisted or braided strands of the rope in the midsection of the rope. The fiber filaments protrude outward from the circumference of the rope similar to the way bristles protrude outward from a brush. The fiber filaments are waterproof and resistant to breaking, splitting & fraying. Preferably, the fiber filaments comprise lengths of “weed-wacker”-type cord, consisting of nylon copolymer resin. Optimally, there are about 40 fiber filaments of 0.155 inch diameter, positioned along an approximate 18-inch length centered at the midpoint of the rope.

The present invention is used in the following way: The gripping means on either end of the rope are held by the operator in either hand to form a half-loop in front of the operator, as if the rope were a jump rope. The half-loop is then tossed over the bow or stern of the personal water craft and slowly dragged along the bottom of the craft until the bristles come into contact with the intake grates. The operator then pulls up alternately on either end of the rope, such that the bristles engage the grates in a lateral back-and-forth reciprocating motion. The action of the bristles against the grates loosens and disengages obstructing materials and clears the grates for unclogged water intake.

### BRIEF DESCRIPTION OF THE DRAWINGS

FIG. 1 is a perspective view of the present invention with the stern of a jet ski shown in ghost view;

FIG. 2 is a perspective view of the mid-section of the present invention;

FIG. 3 is a perspective detail view of the present invention with intertwined fiber filaments; and

FIG. 4 is a perspective detail view of the present invention with glued fiber filaments.

### DETAILED DESCRIPTION OF THE PREFERRED EMBODIMENTS

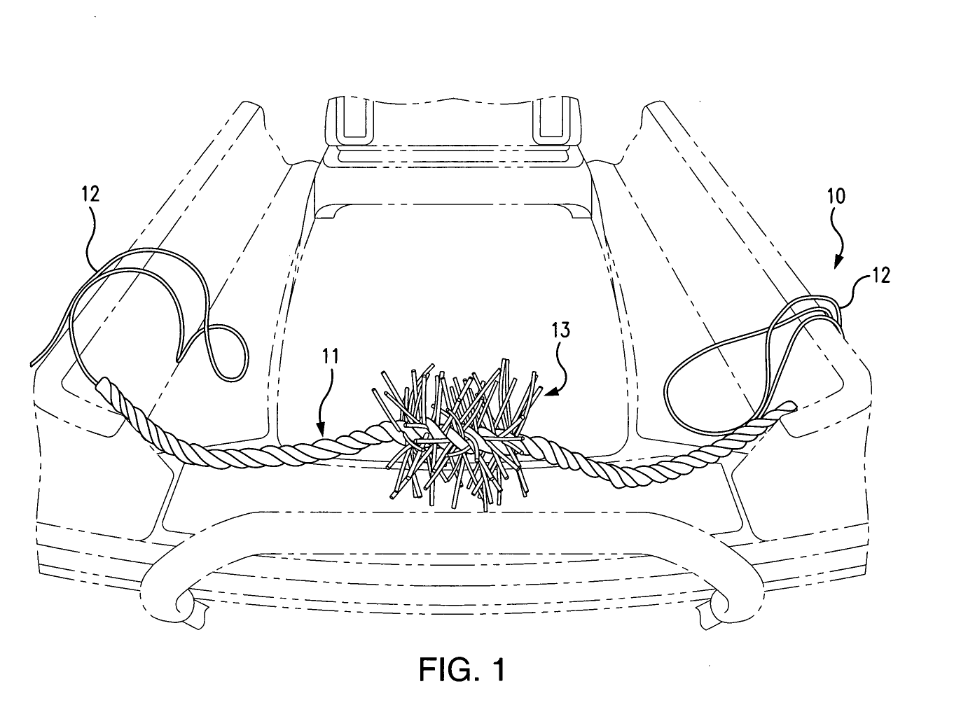

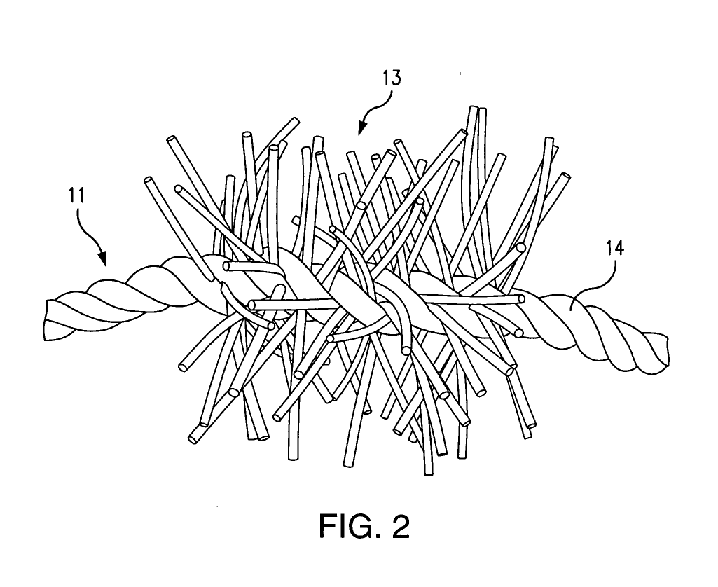

As depicted in FIGS. 1-4, the present invention 10 comprises three components: a length of rope 11, gripping means 12 at either end of the rope, and multiple semi-rigid, flexible fiber filaments 13 protruding outward as “bristles” form the mid-section of the rope. The rope 11 comprises multiple component strands 14, which are twisted or braided together. In the preferred embodiments, the rope 11 is a 3-strand “plain rope”, comprising three ⅝-inch twisted polypropylene strands. Optimally, the rope 11 is approximately 14 feet in length. The gripping means 12 on either end of the rope 11 can be rope loops, plastic or metal handles, taped hand grips, or other functionally equivalent structures.

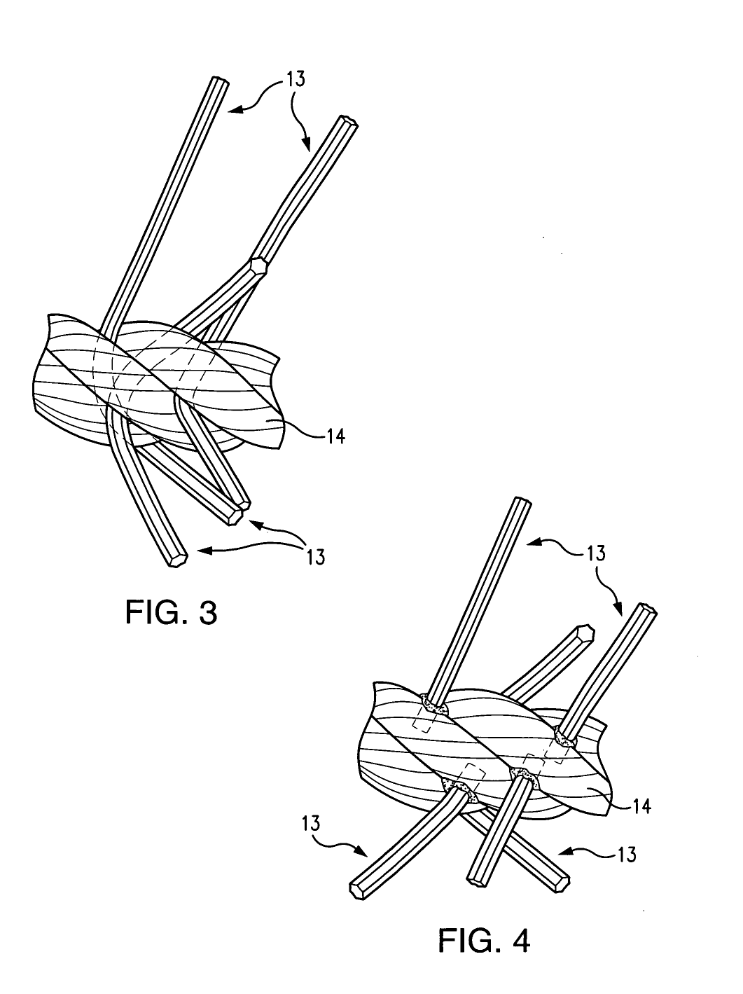

The fiber filaments 13 can be intertwined or interbraided with the rope strands 14 during the manufacture of the rope, as depicted in FIG. 3. Alternately, a “kit version” of the present invention 10 can be practiced by cutting an existing rope to the desired length, loosening the strands 14 of the rope, inserting the fiber filaments 13, and then gluing the fiber filaments 13 in place with a hot glue gun or other equivalent means. The result of this “kit version” is shown in FIG. 4.

In the preferred embodiments, the fiber filaments 13 comprise lengths of “weed-wacker”-type cord, consisting of nylon copolymer resin. Optimally, there are about 40 fiber filaments 13 of 0.155 inch diameter, positioned along an approximate 18-inch length centered at the midpoint of the rope 11.

The present invention 10 is used in the following way: The gripping means 12 are held by the operator in either hand to form a half-loop in front of the operator, as if the rope 11 were a jump rope. The half-loop is then tossed over the bow or stern of the personal water craft and slowly dragged along the bottom of the craft until the bristles come into contact with the intake grates. The operator then pulls up alternately on either end of the rope 11, such that the fiber filaments 13 engage the grates in a lateral back-and-forth reciprocating motion. The action of the fiber filaments 13 against the grates loosens and disengages obstructing materials and clears the grates for unclogged water intake.

Although the preferred embodiments of the present invention has been disclosed for illustrative purposes, those skilled in the art will appreciate that many additions, modifications and substitutions are possible, without departing from the scope and spirit of the present invention as defined by the accompanying claims.

What is claimed is:

1. A device for clearing obstructing materials from the intake grates of a personal water craft, comprising:
a length of rope, comprising multiple strands twisted or braided together, and comprising two ends and a mid-section;
multiple semi-rigid, flexible fiber filaments that are intertwined or interbraided among the strands of the rope along the mid-section of the rope, such that the fiber filaments protrude outward from the surface of the rope; and
gripping means at both ends of the rope, such that the rope can be held at both ends and thrown over the bow or stern of the personal water craft and dragged along the bottom of the craft so that the fiber filaments engage the intake grates, and such that, with the fiber filaments so engaged, the ends of the rope can then alternately be pulled up, thereby causing the fiber filaments to engage the grates in a lateral back-and-forth reciprocating motion, and thereby loosening and disengaging the obstructing materials from the intake grates.

2. The device according to claim 1, wherein the rope comprises twisted polypropylene strands.

3. The device according to claim 1, wherein the fiber filaments comprise nylon copolymer resin.

4. The device according to claim 2, wherein the fiber filaments comprise nylon copolymer resin.

5. The device according to any one of claims 1-4, wherein the fiber filaments are secured among the strands of the rope by an adhesive.
